(19) United States
(12) Patent Application Publication
(10) Pub. No.: US 2009/0291273 A1
(43) Pub. Date: Nov. 26, 2009

(54) Removable Border Ornamentation for Dinnerware and the Like

(76) Inventor: Richele L. Canales, Lincoln, RI (US)

Correspondence Address: K.P. CORRELL AND ASSOCIATES, L.L.P., 270 BELLEVUE AVE., #326, NEWPORT, RI, 02840, US

(21) Appl. No.: 12/469,584

(22) Filed: May 20, 2009

Related U.S. Application Data
(60) Provisional application No. 61/054,659, filed on May 20, 2008.

(51) Int. Cl. B32B 3/10; B32B 27/00

(52) U.S. Cl. 428/195.1

(57) ABSTRACT

A removable dinnerware border decoration including a predefined ink decoration or pattern imprinted on a substrate a substrate. The predefined ink decoration may be seasonal, holiday, religious, or custom decorations. The substrate, such as polyethylene resin exhibits static cling properties for clinging to a dinnerware item such as a plate or bowl. In addition, the ink decoration is non toxic.

### CROSS-REFERENCE TO RELATED APPLICATIONS

This application claims the benefit of U.S. Provisional Application No. 61/054,659 filed May 20, 2008. The disclosure of this Provisional Patent Application is incorporated by reference herein in its entirety.

### BACKGROUND

1. Field of Use

The present invention relates generally to tableware and, more particularly, to removable border ornamentation for dinnerware and the like.

2. Description of Prior Art (Background)

Dinnerware for foods are known in various embodiments, including those having decorative edging configurations at the periphery of trays, bowls and/or plates. U.S. Pat. No. Des. 267,543—Nemura et al discloses a plate with flower-like edging, the plate being integrally molded plastic. In U.S. Pat. No. Des. 230,338—St. Andre et al, a similar molded late is provided with a configuration having alternating open slots around a periphery. These patents do not disclose affixing any form of decorative edging, but rather provide a decorative integrally molded shape.

U.S. Pat. No. 412,604—Croggon discloses a cup having raised tabs for attachment of a sponge for wetting items using the sponge. This product of this patent is not useful as a convenient packing means for food products, especially cookies. Similarly, U.S. Pat. No. Des. 166,940—Ambellan discloses a plywood bowl having cut edge configurations which are deformed to cause the cut plywood to assume an arch.

A decorative plate for cookies and the like is available from Lady Mary, Inc., and is known as a “party tray”. This tray is characterized by a circular cardboard sheet with pleated ribbon sewn directly to the cardboard, the stitches passing through the cardboard and through the pleated ribbon. The pleated ribbon is flat notwithstanding the circular configuration of the ribbon, adjacent folds of the pleats thus diverging outwardly relative to the circular tray. The party tray is provided with a plastic cover sheet, concealing the stitching through the ribbon and cardboard plate.

The Lady Mary, Inc. plate is relatively expensive to make as it and requires an extra sewing operation to that already required to stitch the pleating of the decorative strip. Stitching requires rather precise mechanical controls in order to feed the thread, tension the thread, etc. If these controls are not correct, the stitching can be loose or otherwise come undone. The stitching is effective with corrugated cardboard, but would not be possible, or may be unduly dangerous, with material not readily pierced with a sewing needle.

It is also possible to staple decorative edging around a planar member. This also can be a dangerous procedure for operator, to planar material is not readily pierced. Furthermore, staples are dangerous in connection with food products because any staples which come loose could be inadvertently associated with the food product and eaten by a customer, with possible damage. Similarly, it would be possible to glue a decorative strip around the edge of a tray. Gluing is not preferred because the glue is a foreign substance that may not be appropriately used in close proximity with food. Odor exuded by the glue may be absorbed by the food product. Pieces of glue may come free of the planar member and/or decorative strip, and become associated with the food and eaten.

For all these reasons, e.g., integrally molded plates with permanent or semi-permanent decorations, there exists a need for easily applied and removable dinner ware border decoration.

### BRIEF SUMMARY

The foregoing and other problems are overcome, and other advantages are realized, in accordance with the presently preferred embodiments of these teachings

In accordance with one embodiment of the invention a removable dinnerware border decoration is provided. The removable dinnerware border decoration includes a substrate and a predefined ink decoration imprinted on the substrate.

The invention is also directed towards a removable dinnerware border decoration. The removable dinnerware border decoration includes a substrate sized for dinnerware such as a goblet, a dinner plate, or a bowl. The substrate consists of a polyethylene resin such as, but not limited to, low density polyethylene resin. In addition, a predefined ink decoration imprinted on the substrate consists of food grade ink.

### BRIEF DESCRIPTION OF THE DRAWINGS

FIG. 1, is a perspective view of a removeable border decoration according to principles of the present invention; and

FIG. 2 is a perspective view of a table place setting for entertaining according to the principles of the present invention.

### DETAILED DESCRIPTION

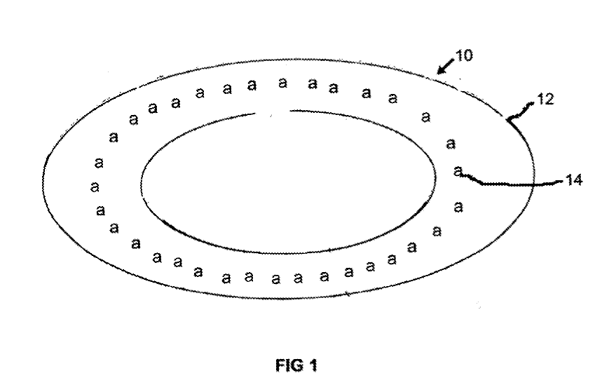

Referring to FIG. 1, a removeable border decoration 10 for dinnerware includes food grade plastic substrate 12 capable of holding an imprint 14 is shown. It will be appreciated that any suitable substrate 12, including any suitable thickness, color, or shape, may be used. For example, the substrate may consist of a food grade plastic or vinly substrate material that exhibits clinging properties due to a small but significant static charge differential between the sheet material and the dinnerware object of application and which will satisfactorily adhere to a variety of dinnerware materials and curved surfaces including porous and irregular shapes.

In one embodiment the substrate may be polyethylene resin or more specifically low density polyethylene. In addition, the substrate may be any suitable substrate that is flexible, printable, food safe, dishwasher/microwave capable, temperature resistant, chemical resistant and/or water resistant.

Suitable static cling plastic sheet material is widely available in a range of weights, stiffnesses, colors and coatings. A typical such material may be a vinyl film product offered in weights from 4.0 mil to 8.0 mil, typically provided in sheets or rolls with a white board backing and typically in clear transparent or white translucent form.

Still referring to FIG. 1, it will also be understood that the substrate 12 may be any suitably sized shape. For example, substrate 12 may be a suitable circular shape sized to fit the circumference of any sized plate. Likewise, the width of substrate 12 may also be any suitable or desired width.

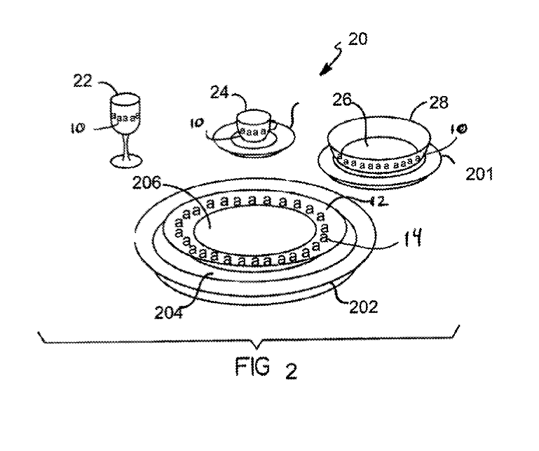

Still referring to FIG. 1, it will be appreciated that the food grade plastic or vinyl substrate 12 may be imprinted with any suitable ink imprint 14. For simplicity, FIG. 2 shows the imprint 14 “a” however, it will be understood that the substrate 12 may be imprinted with any suitable advertising logos, decorative and appealing scenes, holiday themes, seasonal themes, cartoon characters, symbols, shapes, educational features, photographs, amusing features. It will be further understood that the imprint 14 may be any suitable size or color. It will be further appreciated that the ink imprint may use any suitable ink such as food grade ink meeting regulatory safety and non-toxic requirements.

It will also be appreciated that the removable substrate 12 is not permanently associated with the dinnerware and may be changed as desired to recapture a child's attention or when the decoration is outdated.

It will be appreciated that the substrate may be imprinted with any suitable imprinting method such as, but not limited to, hot stamp printing (thermal bond decoration method), pad printing (chemical bond decoration method), offset printing (chemical bond decoration method), and laser printing (thermal bond decoration method).

Referring also to FIG. 2 there is shown a perspective view of a table place setting according to the principles of the present invention. It will be appreciated that the removable substrate 12 may be associated with any appropriate dinnerware as shown in, but not limited to, FIG. 2. Thus, advantageously, avoiding the need for expensive dinnerware with permanently associated decorations. For example, goblet 22 may be any suitable goblet or cup which can facilitate the static cling properties of the removeable border decoration 10. It will be understood that typical decorated goblets are hand painted and thus permanently decorated; however, the present invention allows the use of inexpensive goblets capable of exploiting the static cling properties of the substrate 12.

Still referring to FIG. 2, there is shown a coffee cup 24 with removeable border decoration 10. As noted earlier the removeable border decoration 10 may be imprinted with any suitable imprint on the suitably sized substrate 12. Likewise, bowl 28 and plate 206 may also be decorated with removeable border decoration 10. It will be appreciated that each of the settings shown in the table place setting shown in FIG. 2 may all have matching removeable border decoration 10 or may have coordinated removeable border decorations 10.

It will be understood that the removeable border decoration 10 described herein advantageously limits the expense and storage problems associated with having to purchase multiple sets of dinnerware with different border themes. The removeable border decoration 10 described herein also advantageously gives the consumer the ability to be creative and personalize their dinnerware for separate holidays and/or seasons.

It should be understood that the foregoing description is only illustrative of the invention. Accordingly, the present invention is intended to embrace all such alternatives, modifications and variances which fall within the scope of the appended claims. For example,

What is claimed is:

1. A removable dinnerware border decoration comprising:
a substrate; and
a predefined ink decoration imprinted on the substrate.

2. The removable dinnerware border decoration as in claim 1 wherein the substrate comprises polyethylene resin.

3. The removable dinnerware border decoration as in claim 2 wherein the polyethylene resin comprises low density polyethylene resin.

4. The removable dinnerware border decoration as in claim 1 wherein the predefined ink decoration comprises non toxic ink.

5. The removable dinnerware border decoration as in claim 4 wherein the predefined ink decoration comprises food grade ink.

6. The removable dinnerware border decoration as in claim 1 wherein the substrate further comprises a goblet sized substrate.

7. The removable dinnerware border decoration as in claim 1 wherein the substrate further comprises a plate sized substrate.

8. The removable dinnerware border decoration as in claim 1 wherein the substrate further comprises a bowl sized substrate.

9. A removable dinnerware border decoration comprising:
a substrate sized for dinnerware selected from the group consisting of a goblet, a dinner plate, and a bowl, and wherein the polyethylene resin comprises low density polyethylene resin; and
a predefined ink decoration imprinted on the substrate, wherein the predefined ink decoration comprises food grade ink.
